(19) United States
(12) Patent Application Publication
(10) Pub. No.: US 2015/0210330 A1
(43) Pub. Date: Jul. 30, 2015

(54) MOTOR COMPARTMENT STRUCTURE FOR A VEHICLE AND METHOD OF ATTACHING A MOTOR COMPARTMENT TO A VEHICLE

(71) Applicant: GM GLOBAL TECHNOLOGY OPERATIONS LLC, Detroit, MI (US)

(72) Inventors: Hesham A. Ezzat, Troy, MI (US); Marcel R. Cannon, Romeo, MI (US); Mark A. Nelson, Rochester, MI (US); John T. Freiwald, Onsted, MI (US); Terry A. Swartzell, Ann Arbor, MI (US)

(73) Assignee: GM GLOBAL TECHNOLOGY OPERATIONS LLC, Detroit, MI (US)

(21) Appl. No.: 14/168,662

(22) Filed: Jan. 30, 2014

(51) Int. Cl. B62D 65/02; B62D 25/08

(52) U.S. Cl. CPC B62D 65/02; B62D 25/082

(57) ABSTRACT

A motor compartment structure for a vehicle includes an intermediate joint welded to a forward region of a cab of the vehicle. Also included is an upper motor compartment rail having a forward end and a rearward end, the rearward end mechanically fastened to the intermediate joint.

### FIELD OF THE INVENTION

The subject invention relates to vehicles and, more particularly, to a motor compartment structure, as well as a method of attaching the motor compartment structure to a vehicle.

### BACKGROUND

Body structures for body-on-frame (BOF) vehicles have historically been truncated at the dash panel. The motor compartment upper structure for such executions, referred to as front end sheet metal (FESM) would typically be bolted on post-paint in general assembly.

Assembly plants producing such configurations have a set production line pitch that is consistent with the length of the cab of the vehicle. This makes it challenging to change to a more mass efficient welded on motor compartment structure without incurring significant capital investment in the affected assembly plant(s). Refined noise, vibration and harshness (NVH) performance for such vehicles, particularly the performance affected by front structure modes, combined with pressures to reduce mass, drove a number of manufacturers to abandon the bolt-on FESM approach for the more structurally and mass efficient welded on structure. In many cases, this required a complete rebuild of assembly facilities at considerable cost.

### SUMMARY OF THE INVENTION

In one exemplary embodiment of the invention, a motor compartment structure for a vehicle includes an intermediate joint welded to a forward region of a cab of the vehicle. Also included is an upper motor compartment rail having a forward end and a rearward end, the rearward end mechanically fastened to the intermediate joint.

In another exemplary embodiment of the invention, a vehicle includes a cab having a first forward side and a second forward side. Also included is a first intermediate joint welded to the first forward side. Further included is a second intermediate joint welded to the second forward side. Yet further included is a first upper motor compartment rail having a first forward end and a first rearward end, the first rearward end mechanically fastened to the first intermediate joint. Also included is a second upper motor compartment rail having a second forward end and a second rearward end, the second rearward end mechanically fastened to the second intermediate joint.

In yet another exemplary embodiment of the invention, a method of attaching a motor compartment to a cab of a vehicle is provided. The method includes welding an intermediate joint to a forward region of the cab. The method also includes mechanically fastening an aft end of an upper motor compartment rail to the intermediate joint.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a front end of a vehicle in a pre-assembly position;

FIG. 2 is a perspective view of a motor compartment structure of the front end, of FIG. 1, in an intermediate assembly position;

FIG. 3 is a perspective view of the motor compartment structure of the front end, of FIG. 1, in a fully assembled position; and

FIG. 4 is a flow diagram illustrating a method of attaching a motor compartment to a cab of a vehicle.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

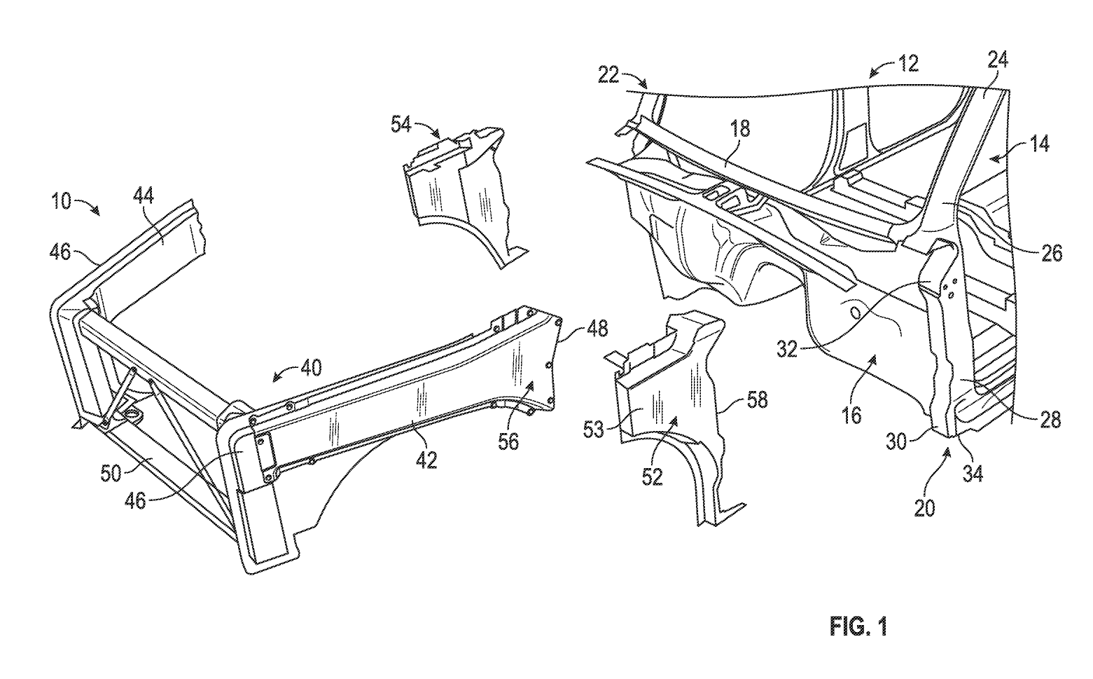

Referring to FIG. 1, in accordance with an exemplary embodiment of the invention, a partially disassembled view of a front end assembly 10 of a vehicle 12 is shown in the form of an automobile. Although the vehicle 12 is illustrated as an automobile, it is to be appreciated that the embodiments disclosed herein may be employed in combination with various alternative types of vehicles. With respect to an automobile, it is to be further appreciated that the specific type of automobile is irrelevant to carrying out the embodiments described below. For example, the automobile may include a car, truck, sport utility vehicle (SUV) or van. The preceding list is merely illustrative and is not intended to be limiting of the numerous automobile types that may benefit from the embodiments of the invention.

The vehicle 12 includes a cab portion 14, of which only a forward region 16 is illustrated. The illustrated components of the cab portion 14 include a dash panel 18, a first forward side 20 and a second forward side 22. The first forward side 20 is disposed in a fore-aft direction of the vehicle 12 at an outermost side of the body of the vehicle 12 prior to installation of a door (not shown) and possibly other components. The second forward side 22 is disposed at the same fore-aft location, but is located on an opposite side of the vehicle 12 from the first forward side 20, with respect to a cross-car direction of the vehicle 12. For purposes of description, only the first forward side 20 will be described in detail, as the second forward side 22 is a substantially similar, mirror-image of the first forward side 20. Therefore, it is to be understood that components described in conjunction with the first forward side 20 are included on the other vehicle side in conjunction with the second forward side 22.

The first forward side 20 includes an A-pillar 24 that extends from a top region (not shown) downwardly to a base region 26. Located proximate, and typically adjacent to, the base region 26 of the A-pillar 24 is a hinge pillar 28. The hinge pillar 28 includes a forward edge 30 and extends from a top end 32 to a bottom end 34.

The front end assembly 10 includes a motor compartment structure 40 having a first upper motor compartment rail 42 and a second upper motor compartment rail 44. Both the first upper motor compartment rail 42 and the second upper motor compartment rail 44 include a forward end 46 and a rearward end 48. Extending between, and operatively coupled to, the forward end 46 of the first upper motor compartment rail 42 and the second upper motor compartment rail 44 is a cross-car support member 50, such as a radiator support or the like. As done above in conjunction with the first forward side 20 and the second forward side 22 of the forward region of the cab portion 14, for purposes of description, only the first upper motor compartment rail 42 will be described in detail, as the second upper motor compartment rail 44 is a substantially similar, mirror-image of that of the first upper motor compartment rail 42. Therefore, it is to be understood that components of the first upper motor compartment rail 42 are included on the other vehicle side in conjunction with the second upper motor compartment rail 42. Additionally, described interactions of the first upper motor compartment rail 42 with other components are present in association with the second upper motor compartment rail 44.

A first intermediate joint 52 and a second intermediate joint 54 are disposed between respective forward edges 30 of the hinge pillars 28 and aft portions 56 of the upper motor compartment rails 42, 44.

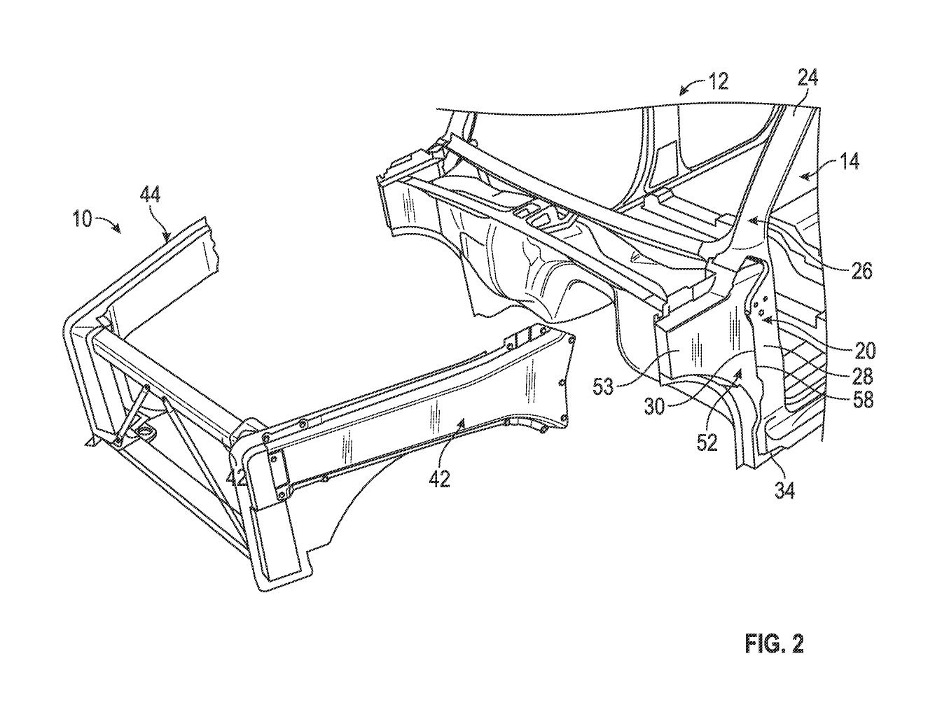

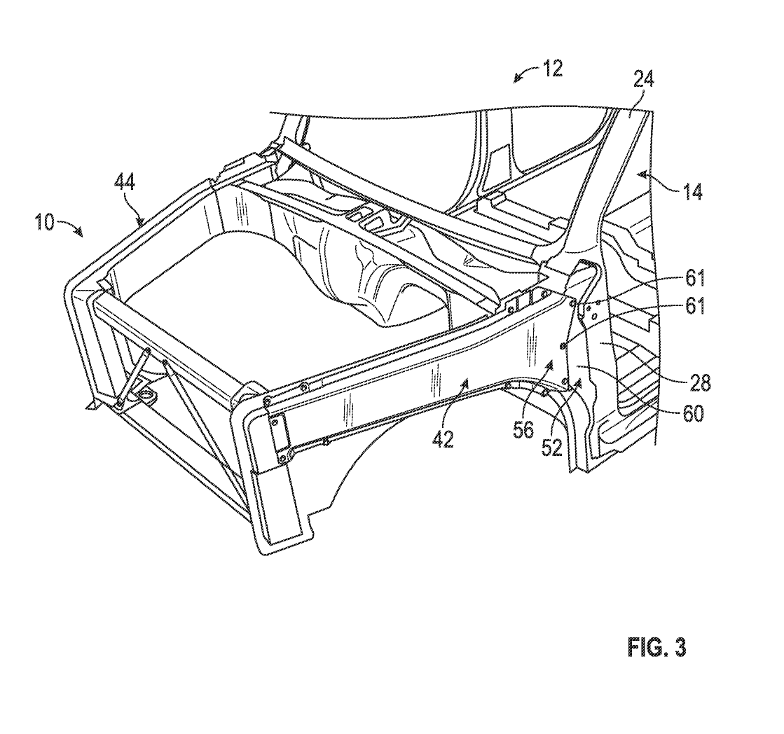

Reference is now made to FIGS. 1-3, which depict detail of the front end assembly 10 and, more particularly, the motor compartment structure 40 in various stages of assembly (FIG. 1, pre-assembled; FIG. 2, partially assembled; and, FIG. 3, assembled).

At the pre-assembly stage, as depicted in FIG. 1, the first upper motor compartment rail 42 and the first intermediate joint 52 are spaced from each other and from the first forward side 20 of the cab portion 14 of the vehicle 12.

Referring to FIG. 2, in the partially assembled condition, the first intermediate joint 52 is welded to a first forward side 20 of the cab portion 14. Specifically, a rear edge 58 of the first intermediate joint 52 is disposed in contact with and welded to a forward edge 30 of the hinge pillar 28. In one embodiment, the rear edge 58 of the first intermediate joint 52 is welded to the first forward side 20 of the cab portion 14 from the base region 26 of the A-pillar 24 through the bottom end 34 of the hinge pillar 28.

Referring to FIG. 3, in the fully assembled condition, the aft portion 56 of the first upper motor compartment rail 42 is slid over a portion of the first intermediate joint 52 to overlap the aft portion 56 of the first upper motor compartment rail 42 with a portion of the first intermediate joint 52. The overlapped disposition of the aft portion 56 having a shape that is sized and configured to at least partially surround a portion of the first intermediate joint 52. The aft portion 56 is at least in an overlapped position with an outer edge 60 of the first intermediate joint 52. In an embodiment the first upper motor compartment rail 42 has a recessed area having an opening on end 48 that is sized to be slidably received on a protrusion 53 of the first intermediate joint 52, FIG. 2. In the exemplary embodiment, the first upper motor compartment rail 42 is slid onto the first intermediate joint 52 in a forward to aft direction. In another embodiment, the sliding motion is in a top to bottom or bottom to top direction.

Upon reaching the overlapped position between the aft portion 56 of the first upper motor compartment rail 42 and the first intermediate joint 52, the first upper motor compartment rail 42 is mechanically fastened to the first intermediate joint 52. In one embodiment, a plurality of mechanical fasteners, such as bolts 61 for example, are inserted through apertures (not shown) of the aft portion 56 of the first upper motor compartment rail 42 and the first intermediate joint 42. With the first upper motor compartment rail 42 and second upper motor compartment rail 44 coupled to the intermediate joints 52, 54 respectively, the front end assembly 10 is attached to the cab portion 14 of vehicle 12.

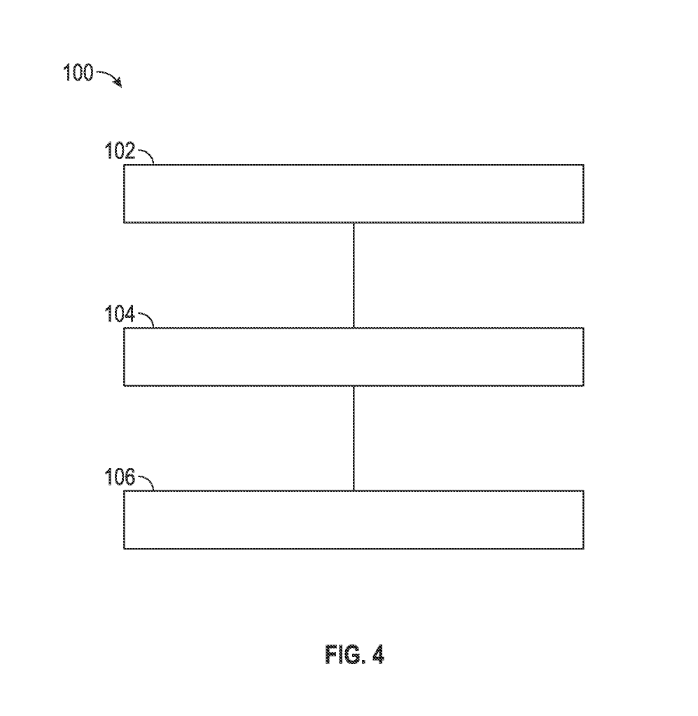

A method of attaching 100 the motor compartment structure 40 to the cab 14 of the vehicle 12 is also provided, as illustrated in FIG. 4, and with reference to FIGS. 1-3. The front end assembly 10, and more specifically the motor compartment structure 40, has been previously described and specific structural components need not be described in further detail. In one embodiment, the method 100 includes welding 102 the intermediate joint 52 to a forward region of the cab 14. The method 100 also includes sliding 104 the aft end 56 of the upper motor compartment rail 42 over at least a portion of the intermediate joint 52 to at least partially surround the intermediate joint 52. The method further includes mechanically fastening 106 the aft end 56 of the upper motor compartment rail 42 to the intermediate joint 52, such as by bolting the components together.

Advantageously, the embodiments described above provide front end structural performance and mass efficiency that is equivalent to a welded front end while still allowing a bolt-on front end sheet metal (FESM) assembly strategy. The assembly and method described above avoids the need for significant overhaul of the assembly line and manufacturing process, thereby reducing associated cost while also maintaining the advantage of having a bolt-on front motor compartment structure to allow for interchangeable motor compartments as needed for different powertrain sizes or differently styled vehicles. It is also possible to leverage this bolt-on/bolt-off feature in simplifying in-field vehicle service/repair. Embodiments further provide advantages in having a front end structure that is more mass efficient and has improved dimensional quality over the FESM type assembly.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. A motor compartment structure for a vehicle comprising:
an intermediate joint welded directly to a forward edge of a hinge pillar;
an upper motor compartment rail having a forward end and a rearward end, the rearward end mechanically fastened to the intermediate joint with at least one bolt; and
a protrusion extending outwardly in a cross-car direction from the intermediate joint, the protrusion having a geometry corresponding to a recessed area defined by an aft portion of the upper motor compartment rail and disposed therein in an overlapped arrangement with the upper motor compartment rail.

2. (canceled)

3. (canceled)

4. The motor compartment structure of claim 1, wherein the intermediate joint is welded to the forward region of the cab from a base region of an A-pillar to a bottom portion of a hinge pillar.

5. (canceled)

6. The motor compartment structure of claim 1, further comprising a plurality of bolts extending through the aft portion of the upper motor compartment rail, the plurality of bolts configured to mechanically fasten the aft portion to the intermediate joint.

7. A vehicle comprising:
a cab having a first forward side and a second forward side;
a first intermediate joint welded directly to a forward edge of a first hinge pillar;
a second intermediate joint welded directly to a forward edge of a second hinge pillar;
a first upper motor compartment rail having a first forward end and a first rearward end, the first rearward end mechanically fastened to the first intermediate joint with at least one bolt;
a first protrusion extending outwardly in a cross-car direction from the first intermediate joint, the first protrusion having a geometry corresponding to a recessed area defined by an aft portion of the first upper motor compartment rail and disposed therein in an overlapped arrangement with the first upper motor compartment rail;
a second upper motor compartment rail having a second forward end and a second rearward end, the second rearward end mechanically fastened to the second intermediate joint with at least one bolt; and
a second protrusion extending outwardly in a cross-car direction from the second intermediate joint, the second protrusion having a geometry corresponding to a recessed area defined by an aft portion of the second upper motor compartment rail and disposed therein in an overlapped arrangement with the second upper motor compartment rail.

8. (canceled)

9. (canceled)

10. The vehicle of claim 7, wherein the first intermediate joint is welded to the first forward side of the cab from a base region of a first A-pillar to a bottom portion of a first hinge pillar, and wherein the second intermediate joint is welded to the second forward side of the cab from a base region of a second A-pillar to a bottom portion of a second hinge pillar.

11. (canceled)

12. The vehicle of claim 7, further comprising a plurality of bolts extending through the aft portion of the first upper motor compartment rail and the second upper motor compartment rail, the plurality of bolts configured to mechanically fasten the aft portion of the first upper motor compartment rail to the first intermediate joint and the aft portion of the second upper motor compartment rail to the second intermediate joint.

13. The vehicle of claim 7, wherein the vehicle is a body-on-frame type of automobile.

14. A method of attaching a motor compartment to a cab of a vehicle comprising:
welding an intermediate joint directly to a forward edge of a hinge pillar;
sliding a recessed area defined by an aft portion of an upper motor compartment rail over a protrusion extending outwardly in a cross-car direction from the intermediate joint in an overlapped arrangement, the protrusion having a geometry corresponding to the recessed area; and
mechanically fastening an aft end of an upper motor compartment rail to the intermediate joint with at least one bolt.

15. (canceled)

16. The method of claim 14, further comprising welding the intermediate joint to the forward region of the cab from a base region of an A-pillar to a bottom portion of the hinge pillar.

17. (canceled)

18. (canceled)
